(19) United States
(12) Patent Application Publication
(10) Pub. No.: US 2015/0046856 A1
(43) Pub. Date: Feb. 12, 2015

(54) Interactive Charts For Collaborative Project Management

(71) Applicant: SmartSheet.com, Inc., Bellevue, WA (US)

(72) Inventors: Erik Rucker, Seattle, WA (US); Charlotte Fallarme, Seattle, WA (US); Kyan Duane Skeem, Bellevue, WA (US); Ronald C. Taylor, Newcastle, WA (US); Thomas P. Maliska, JR., Olympia, WA (US)

(73) Assignee: SmartSheet.com, Inc., Bellevue, WA (US)

(21) Appl. No.: 14/205,277

(22) Filed: Mar. 11, 2014

Related U.S. Application Data
(60) Provisional application No. 61/862,919, filed on Aug. 6, 2013.

(51) Int. Cl. G06F 3/0488

(52) U.S. Cl. CPC G06F 3/0488
USPC 715/765; 715/779; 715/863

(57) ABSTRACT

In one aspect, a computing device with a touchscreen (e.g., a tablet computer, smart phone, etc.) renders an initial interactive chart view (e.g., a Gantt chart view) having a time axis and a task axis, receives user input (e.g., a pinch gesture) associated with a zoom operation, determines whether the zoom operation is one-dimensional or multi-dimensional, and renders a zoom-adjusted interactive chart view (e.g., zooming in or out on the time axis, the task axis, or both). In another aspect, a computing device renders a chart view comprising a time axis and a task row having a task name label with a directional indicator, renders the directional indicator such that it points in the direction of a task bar, receives user input associated with a change in the current position of the task bar, and adjusts the directional indicator based on the change in the current position.

### CROSS-REFERENCE TO RELATED APPLICATION

This application claims the benefit of U.S. Provisional Application No. 61/862,919, filed Aug. 6, 2013, the disclosure of which is hereby incorporated by reference herein in its entirety.

### BACKGROUND

Enterprise software in a hosted web browser environment has typically been driven by efforts to replicate mainline applications on the desktop, with all of their complexity and user interface options. Rich client applications and broadband connections to data sources are presently available for tasks such as word processing, spreadsheet, presentation, image and video manipulation, project management, and other such productivity applications. Similarly, strategies for the synchronization of data and actions between the online application system and the end user client computing device, and the display of the user interface on the client, are well known.

However, the advent of mobile and tablet devices with touchscreen displays, and their popularity with the consumer and business user, mandates a different direction for the presentation of software products. It is particularly challenging for mobile applications, especially applications relating to complex subjects such as project management, to simplify the user experience for successful presentation and manipulation of information on a smaller screen and tune the application for successful deployment on mobile networks with lower network bandwidth. It is also desirable to empower users to customize the display of information dynamically on a mobile or touchscreen device.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computing device with a touchscreen (e.g., a tablet computer, smart phone, etc.) renders an initial interactive chart view (e.g., a Gantt chart view) comprising a time axis and a task axis and receives first user input (e.g., a pinch gesture) associated with a zoom operation via the touchscreen. Based at least in part on the first user input, the computing device determines whether the zoom operation is a one-dimensional zoom operation or a multi-dimensional zoom operation and renders a zoom-adjusted interactive chart view for display responsive to the first user input. In a time-axis zoom operation, the zoom-adjusted interactive chart view can be zoomed in or out on the time axis relative to the initial interactive chart view. In a task-axis zoom operation, the zoom-adjusted interactive chart view can be zoomed in or out on the task axis relative to the initial interactive chart view. In a multi-dimensional zoom operation, the zoom-adjusted interactive chart view can be zoomed in or out on the time axis and the task axis relative to the initial interactive chart view.

The initial interactive chart view may comprise an initial time scale and an initial number of task rows to be displayed. The zoom-adjusted interactive chart view may comprise an adjusted height or number of task rows to be displayed and/or an adjusted time scale. The initial interactive chart view may comprise a number of connection lines representing dependencies to be displayed. The zoom-adjusted interactive chart view may comprise an adjustment of the number, positioning, or orientation of the connection lines.

Additional user input can be used to perform other operations. For example, the computing device can receive second user input (e.g., a tap gesture or press-and-hold gesture) associated with an operation in a task row via the touchscreen and render a modified view of task information responsive to the second user input. Rendering the modified view of task information may include expanding or collapsing an element, repositioning (e.g., centering) a task label on the display, rendering a row view, or rendering a row menu. The row menu may include a dependencies button configured to, when activated, highlight dependences for a task.

In another aspect, a computing device renders a chart view (e.g., a Gantt chart view) comprising a time axis and a task row having a task name label with a directional indicator. The computing device renders the directional indicator such that it points in the direction of a task bar at a current position. The task bar is associated with the task row. The computing device receives user input associated with a change in the current position of the task bar and adjusts the directional indicator based at least in part on the change in the current position of the task bar. The directional indicator can be initially positioned at a first end of the task name label and the directional indicator can be positioned at a second end of the task name label. Adjusting the directional indicator can include adjusting the size or orientation of the directional indicator or adjusting the size of the directional indicator in proportion to a distance between the task name label and the task bar.

In another aspect, a computing device renders a chart view for a project comprising tasks and detects a pinch gesture via a touchscreen. The pinch gesture corresponds to a zoom operation. The computing device automatically adjusts a time scale of the time axis responsive to the pinch gesture subject to a time scale adjustment constraint that is based at least in part on the tasks. The time scale adjustment constraint may include a minimum number of tasks to be visible at the adjusted time scale. The time scale adjustment constraint may require an entire task to be visible at the adjusted time scale.

A computing device performing such methods may be in communication with a server computer, and chart views may be generated using project schedule information received from the server computer. Changes made to the project schedule information can be synchronized back to the server.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A and 1B depict an illustrative computing device configured to present a user interface comprising an interactive chart view to a user;

FIG. 2 is a screen shot of a user interface comprising an illustrative chart view having a time axis and a task axis;

FIGS. 3A-3C are screen shots of a portion of an illustrative chart view in different states;

FIG. 3D is a screen shot of a portion of another illustrative chart view;

FIGS. 4A-D are screen shots of an illustrative chart view at 4 different time scales;

FIG. 5 is a table depicting illustrative date formats for time markers;

FIG. 6 is a screen shot of another illustrative chart view comprising column dividers corresponding to different timescales;

FIG. 7 is a screen shot of an illustrative chart view at an initial zoom level;

FIG. 8 is a screen shot of the illustrative chart view of FIG. 7 in a view state that is zoomed out along the task axis;

FIGS. 9A and 9B are diagrams of illustrative angle ranges for determining whether a pinch gesture is vertical, horizontal, or diagonal;

FIG. 10 is a screen shot of a portion of an illustrative chart view comprising a row menu;

FIG. 11A depicts an illustrative chart view comprising a row menu;

FIG. 11B depicts highlighting of dependencies in the chart view of FIG. 11A that can be performed in response to a selection in the row menu of FIG. 11A;

FIGS. 12 and 13 are flow charts illustrating computer-implemented methods according to one or more embodiments of the present disclosure; and

FIG. 14 is a block diagram that illustrates aspects of an exemplary computing device appropriate for use in accordance with embodiments of the present disclosure.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

According to some embodiments of the present disclosure, solutions are provided for the management and presentation of information (e.g., task, status, and calendar information) in interactive charts. Described embodiments may be implemented in the context of a hosted project management application presented on a mobile device, in which the mobile device presents a user interface that allows interaction with project information provided by a remote device, such as a server. Alternatively, according to principles described herein, management and presentation of such information (or other information) can be performed in the context of other applications and/or on other types of devices.

According to some embodiments of the present disclosure, an interactive chart view application is provided that allows interaction with charts having a time axis and a task axis (e.g., charts for project scheduling). A Gantt chart is an example of a chart that can be used for project scheduling. In a Gantt chart, projects are broken down into tasks. The tasks in a Gantt chart are typically shown with reference to a timeline. A task may be represented with a graphic, such as a bar or line, in the chart. The characteristics of the graphic and its position in the chart can provide information about the task. For example, the length of a bar or line that represents a particular task can provide an indication of how long the task is expected to take to complete. As another example, the position of the bar or line along the timeline can indicate when the task is scheduled to begin or to be completed. Tasks may be dependent on one other. For example, one task may need to be completed before another task can begin. Dependencies between tasks can be depicted (e.g., graphically) in the chart.

Although some embodiments that may be used for project scheduling and collaboration are described herein with reference to Gantt charts, it should be understood that such embodiments may also be applied to other types of project scheduling charts, or other charts that are not specifically limited to project scheduling.

According to some embodiments of the present disclosure, modifiable views of project information are provided. Such views can be modified according to display rules. Modifications of views can be initiated and controlled by user interface elements. For example, on a mobile device with a touchscreen interface, modifications of views can be initiated and controlled by gestures, button taps, or other user interactions. For example, a Gantt view provided for interaction with a Gantt chart can be dynamically modified according to a pre-defined set of display rules and related user interface elements.

In some embodiments, multiple views are provided. The respective views can be displayed individually, or multiple views (or portions of views) can be displayed at the same time, depending on factors such as the available screen area for displaying views. As used herein, a view refers to a depiction of a portion of a user interface that relates to a particular type of content. For example, a chart view depicts content relating to a chart (e.g., a Gantt chart). A chart view that depicts a Gantt chart can be referred to as a Gantt view. In one illustrative embodiment, three views are provided to facilitate user interaction with a Gantt chart: a Gantt view, a list view, and a grid view.

In described embodiments, an interactive chart view application provides views that can be rich in graphics and other information without providing unnecessary distractions. Such views allow the user's data to be easily viewable and accessible on a small display, such as a display on a mobile phone. The views are also flexible enough to take advantage of larger displays, such as tablet PC displays, allowing users to use different devices as their needs and resources change.

Treatment of views and view states can vary depending on application design, user preferences, or other factors. For example, an interactive chart view application may be configured to store a current view state when a user exits the application, and the stored view state can be automatically restored when the application is opened again. Alternatively or additionally, default views and/or view states can be used. For example, an interactive chart view application may be configured to display a default view each time the application is opened. As another example, a user can choose to display a default view or a previously stored view state when the application is opened. The default view may be customizable or pre-defined. For example, a user can select a Gantt view, list view, or grid view as a default view.

A user can interact with views (including Gantt views) in various ways. For example, views can be initiated, selected, modified, and/or manipulated on mobile devices using onscreen or physical device buttons, taps or gestures, movements of the device itself (e.g., shaking), voice commands, menu-selected user interface options, or any other suitable method. The invocation of a view (e.g., a Gantt view) may invoke a modal view (e.g., a view that is displayed until dismissed, modified, or a change is requested), or it may invoke a transparent or semi-transparent temporal view. For example, a Gantt view can overlay an overall project view or some other view for a period of time (e.g., a period of time after shaking the device) or pendency of an action (e.g., holding a touch on a button).

### Illustrative Interactive Chart Views

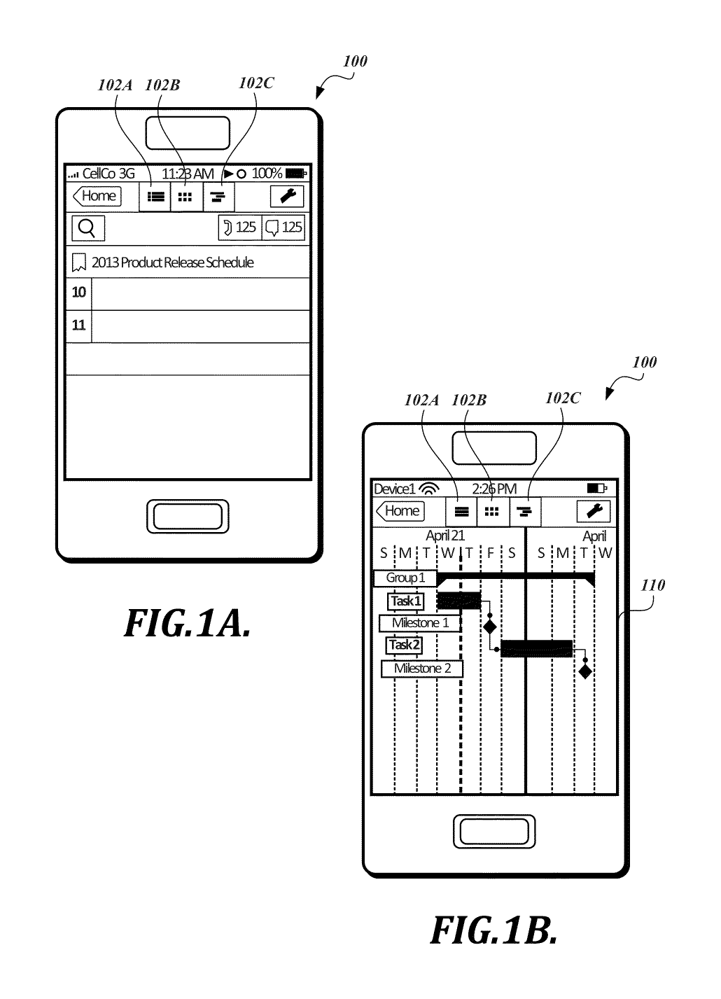

FIGS. 1A and 1B depict an illustrative computing device 100 (e.g., a touch-enabled mobile computing device) configured to present a user interface comprising an interactive chart view 110 to a user. As shown in FIGS. 1A and 1B, the user interface is provided by an interactive chart view application and comprises a view switcher comprising three view-switching buttons 102A-C. In FIG. 1B, an illustrative chart view 110 (e.g., a Gantt view) is shown. The chart view 110 may be accessed via the chart view button 102C on the view switcher. In at least one embodiment, the chart view 110 is a Gantt view that is a peer to a list view (which may be accessed via list view button 102A) and a grid view (which may be accessed via grid view button 102B). A user may switch between views (e.g., by tapping or otherwise activating view-switching buttons 102A-C), as desired. Illustrative examples of Gantt views are described in further detail below.

Although the chart view 110 shown in FIG. 1B is depicted as being presented independently of other views, it is also possible for multiple views (or portions of views) to be displayed at the same time. For example, a grid view or list view can be displayed alongside the chart view 110, or other combinations of views can be displayed.

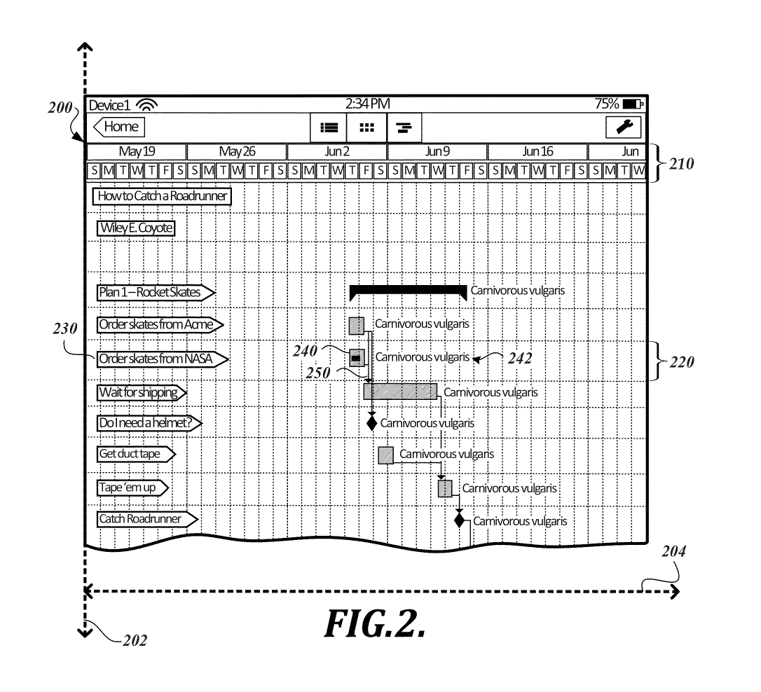

FIG. 2 is a screen shot of a user interface comprising an illustrative Gantt view 200 having a time axis 204 (depicted as a horizontal axis in this example) and a task axis 202 (depicted as a vertical axis in this example). It should be understood that the orientation of the time axis and the task axis in FIG. 2 is only an example. The orientation of the time axis and the task axis could be reversed (with the time axis oriented vertically and the task axis oriented horizontally) or modified in some other way.

In the example shown in FIG. 2, a header row 210 associated with the time axis 204 is displayed across the top of the Gantt view 200. The time axis 204 is associated with a time scale. In the example shown in FIG. 2, the time scale includes two levels of hierarchy (e.g., days and weeks) that are depicted in the header row 210. Although some examples are described herein with reference to two-level time scales (e.g., day/week, week/month, month/quarter, quarter/year, etc.), single-level time scales (e.g., day), three-level time scales (e.g., day/week/month), or other types of time scales also can be used. A user can zoom in or out and snap to broader or narrower time scales. In at least one embodiment, such zooming functions can be performed with a gesture (e.g., a pinch gesture) in a touch-enabled interface, as described in further detail below.

In the example shown in FIG. 2, task rows (e.g., task row 220) are associated with tasks. Task rows may include task name labels, task bars, task bar labels, connection lines, and/or other elements. In FIG. 2, an illustrative task row 220 includes a task name label 230 associated with a task bar 240 and connection lines 250. The connection lines 250 show dependency relationships (e.g., with arrows showing direction of precedence from a predecessor task to a successor task). Connection lines may be positioned at least in part behind other elements such as task bars and task bar labels in order to avoid obscuring the other elements.

In the example shown in FIG. 2, the task bar 240 contains an interior portion (e.g., a darker-shaded rectangle) within the task bar 240 that shows progress of the corresponding task. In at least one embodiment, the length of the interior portion relative to the length of the task bar represents how much of the associated task has been completed (e.g., as a percentage of the task).

The task bar 240 also has an associated task bar label 242. The task bar label 242 can provide additional information about the task, such as the person or entity responsible for completing the task. In the example shown in FIG. 2, the task bar label 242 is positioned to the right of the task bar 240. The information to be displayed in the task bar label 242 may be selectable (e.g., automatically or by a user) or predefined. In at least one embodiment, the user can choose which field is displayed in a floating label by selecting from a number of available options (e.g., from a menu or dialog box). In at least one embodiment, available options for the task bar label 242 are displayed with a heading of “Display labels for:” and include options such as “Assigned to,” which may be used as a default setting to set the task bar label 242 to indicate which person or entity the corresponding task is assigned to (e.g., “Carnivorous vulgaris”).

Different portions of a chart view may be allocated respective percentages of the display area. For example, a portion of a Gantt view that includes task bars 240 and connection lines 250 may be allocated 40% of the width of the display area. As another example, the size of task name labels 230 can be limited to a percentage of the display area (e.g., 45% of the width of the display area).

Elements of a chart view (e.g., task name labels, task bars, etc.) may be presented as transparent, semi-transparent, or opaque, and the transparency of such elements can vary depending on the view state. For example, the task name labels 230 may be semi-transparent (allowing content behind them, such as task bars, to be partially visible) or opaque.

In some embodiments, an interactive chart view application can track dimensions of the screen allocated to display the application data and the interactions of the mobile device user. Some rules that may be used in such embodiments are described below with reference to corresponding figures.

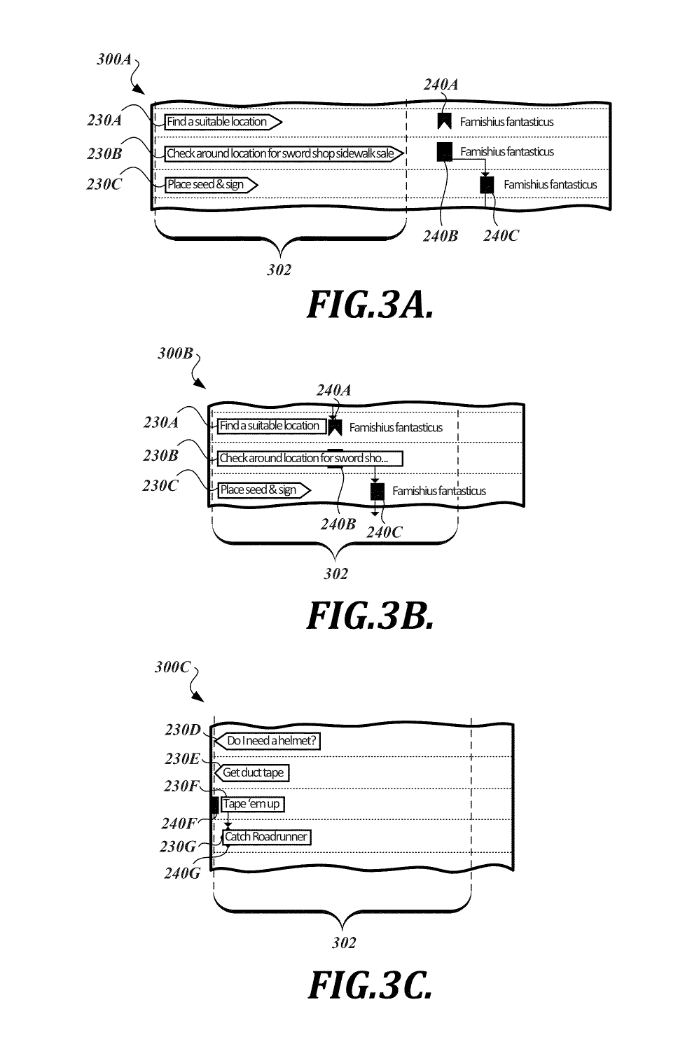

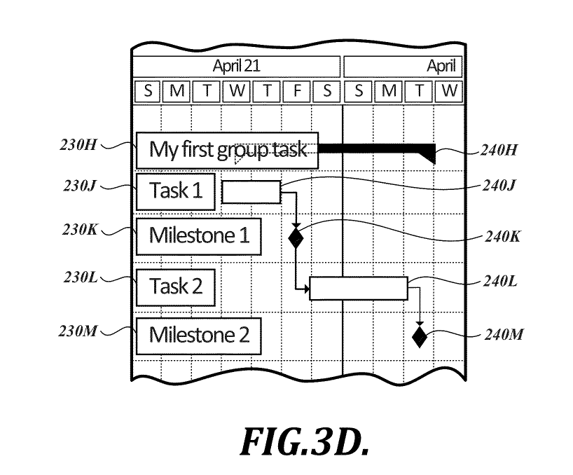

FIGS. 3A-3C show different states of a Gantt view. In state 300A (FIG. 3A), the text within task name labels 230A-C is shown in full. The width of the task name labels 230A-C may extend to as much as the full width of the usable display area. However, in at least one embodiment, the width of task name labels is limited to a predetermined fraction of the display area. In state 300A, the task name labels 230A-C are shown in the display area 302, the horizontal extent of which is indicated by vertical dashed lines, while other elements (e.g., task bars 240A-C) are outside the display area 302.

The appearance of some elements can be altered in response to events. For example, in state 300B (FIG. 3B), the appearance of the task name label 230B has changed relative to state 300A (FIG. 3A) by becoming shorter, changing shape (e.g., changing a pointed end to a square end), and replacing a portion of the text with an ellipsis, in response to the movement of task bar 240B into the display area 302. An ellipsis or other indicator may be used, for example, if the text in the label is wider than the display area or a maximum width assigned to the label. As another example, to distinguish the task name labels 230A-C from other information, one or more of the task name labels 230A-C may be made smaller or larger in one or more dimensions (e.g., vertically), which may have the effect of making other elements (e.g., the corresponding task bars 240A-C) more visible around the respective labels 230A-C.

Some elements can be configured to float over the Gantt view. For example, in state 300B (FIG. 3B), as the user scrolls horizontally the task name labels 230A-C can remain in place and float over corresponding task bars 240A-C. This allows the user to keep track of which tasks are being viewed without requiring an adjacent, separate view, such as a grid view. The task bars 240A-C can be depicted as sliding under the corresponding task name labels 230A-C as the user scrolls horizontally. Such movement may continue, for example, beyond the edge of the screen, to the edge of the screen, or until an allocated percentage of the display area is reached. In state 300B (FIG. 3B), these rules are applied to show that, in response to an adjustment in display area 302, task name label 230A changes from a pointed end to a square end; task name label 230B changes from a pointed end to a square end, the text is shortened with an ellipsis, and the task bar 240B slides under the task name label 230B; and task name label 230C remains unchanged. The task bars 240A-C move horizontally left. Note that although changes described with reference to FIGS. 3A-B are due to horizontal scrolling, elements may also change appearance in the display area in response to other events, such as editing of the text contained in the name labels, whether by shortening or lengthening the text, changing the font characteristics, and so on.

Changing to a landscape orientation (e.g., by rotating the display) can provide a greater screen width. To take advantage of changes in display orientation, at least some aspects of the Gantt view (e.g., the size of task name labels, the length the time axis, etc.) can be automatically adjusted in response to a change in display orientation (e.g., from portrait to landscape orientation, or vice versa).

Task name labels may include a directional indicator (e.g., an arrow or chevron pointer) to indicate where corresponding task bars are located relative to the task name labels. For example, in FIG. 3A, right-pointing directional indicators are used on the task name labels 230A-C to indicate that the corresponding task bars 240A-C are to the right and will become visible if the corresponding portion of the Gantt view is repositioned to bring the task bars 240A-C into the display area. In FIGS. 3B and 3C, task name labels 230A, 230B, 230F, and 230G are square on each end to indicate that the corresponding task bars 240A, 240B, 240F, and 240G are immediately adjacent to or beneath the respective labels. As a user scrolls horizontally, the directional indicator can gradually shrink in size and/or change in shape as the task bar approaches the task name label. The directional indicator can be repositioned on the other side of the label and gradually grow and/or change in shape as the user scrolls past. For example, in FIG. 3C, left-pointing directional indicators are used on the task name labels 230D and 230E to indicate that the corresponding task bars 240D and 240E are to the left, outside the display area 302.

FIG. 3D is a screen shot of a portion of another illustrative Gantt view. In the example shown in FIG. 3D, task name labels 230H-M are left-aligned and vertically centered in respective task rows. The task name label 230H has a translucent background (e.g., 15% gray with 15% transparency) that allows text in the label to remain visible despite the translucence of the background, while also allowing an associated task bar 240H to be partially visible through the task name label 230H. In the example shown in FIG. 3D, the group task bar 240H has small triangles at either end indicating the extent of a corresponding group of tasks and/or milestones. In at least one embodiment, the middle portion between the triangles is half the height of a task bar (e.g., task bar 240J), and when the group task bar 240H changes in size (e.g., in response to a zoom operation), the only part that grows or shrinks is the middle portion between the triangles, which do not change shape.

Task name labels 230J and 230L are associated with task bars 240J and 240L, respectively. In at least one embodiment, the task bars 240J and 240L are rectangles with a height equal to the height of the text in the corresponding task name labels 230J and 230L, respectively, with a gray border and a colored fill that can be customized, e.g., to represent different types of tasks.

Task name labels 230K and 230M are associated with milestone markers 240K and 240M, respectively. Milestone markers can be considered a special type of task bar associated with a milestone. In at least one embodiment, if the user sets a task to zero time length, the task is represented as a milestone marker (e.g., a black diamond). The milestone marker can be vertically and horizontally centered within the box representing the corresponding time period, as shown in FIG. 3D, or presented in some other way.

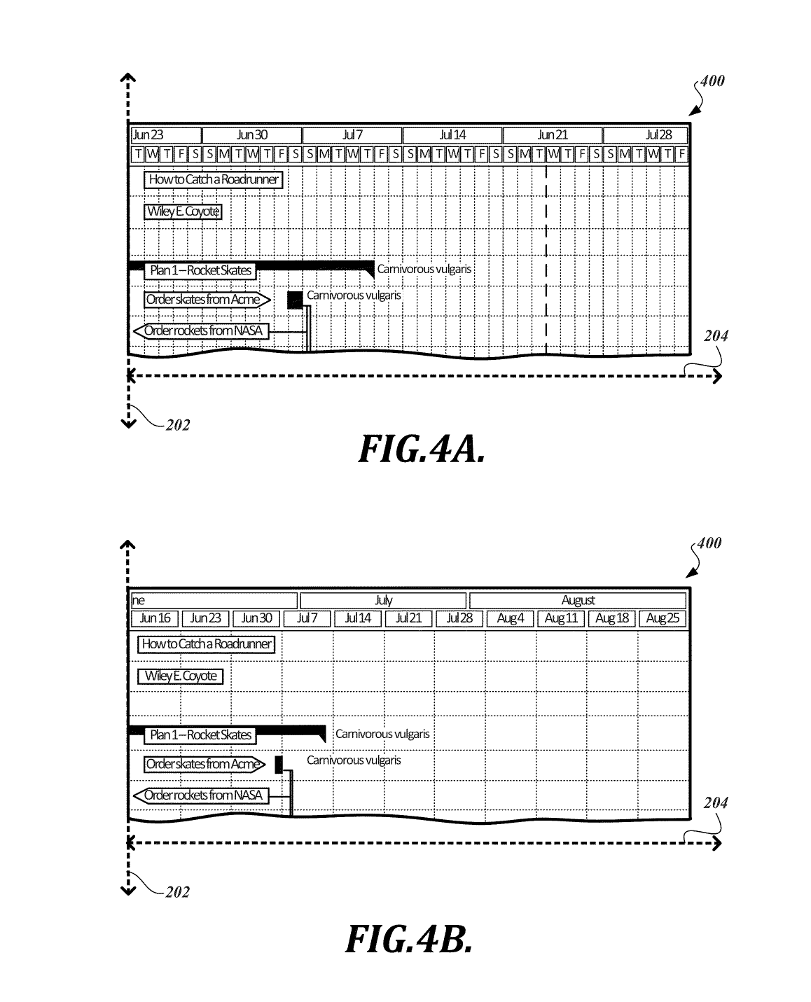

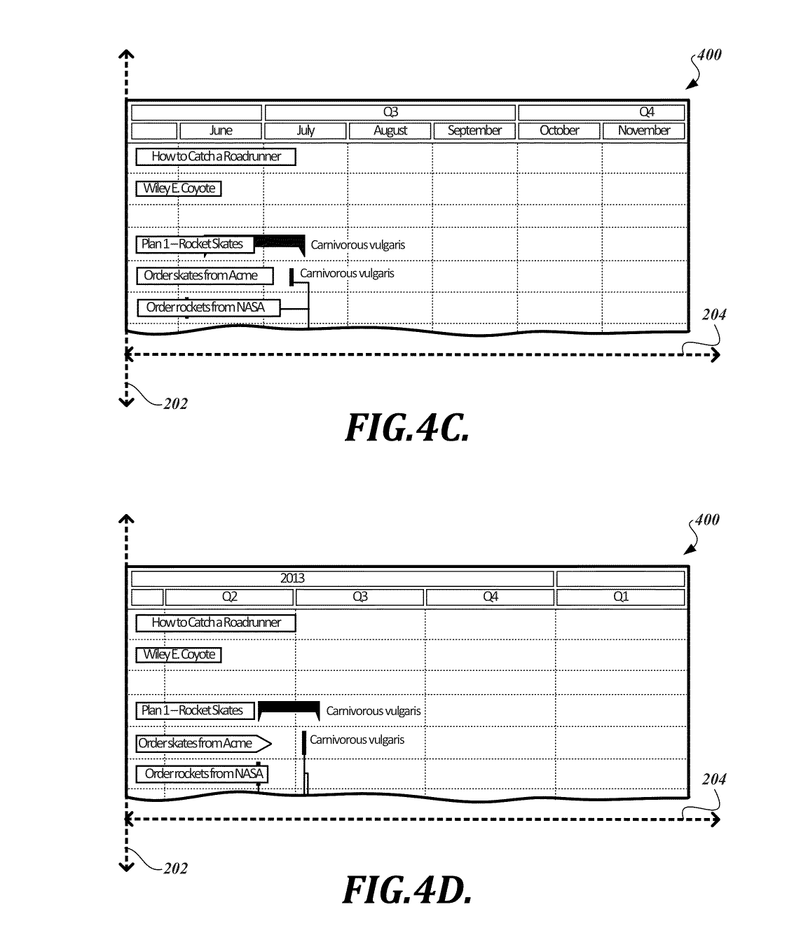

As indicated above, in described embodiments a chart view comprises a time axis. The time axis may have an associated header with multiple levels of time markers (e.g., letters representing days of the week, names of months, etc.) and multiple available time scales and levels of zoom. FIGS. 4A-D are screen shots of an illustrative chart view 400 at 4 different time scales. Possible time scales include days/weeks (FIG. 4A), weeks/months (FIG. 4B), months/quarters (FIG. 4C), and quarters/years (FIG. 4D). As explained above, although some examples are described herein with reference to two-level time scales (e.g., day/week, week/month, month/quarter, quarter/year, etc.), single-level time scales (e.g., day), three-level time scales (e.g., day/week/month), or other types of time scales also can be used.

The time scales and the associated time markers can be updated automatically in response to zooming in or out on the time axis 204. Alternatively, the levels of time markers can be adjusted independently. As another alternative, one or more of the time scales may be fixed. Further details regarding zooming functionality and time scales are provided below.

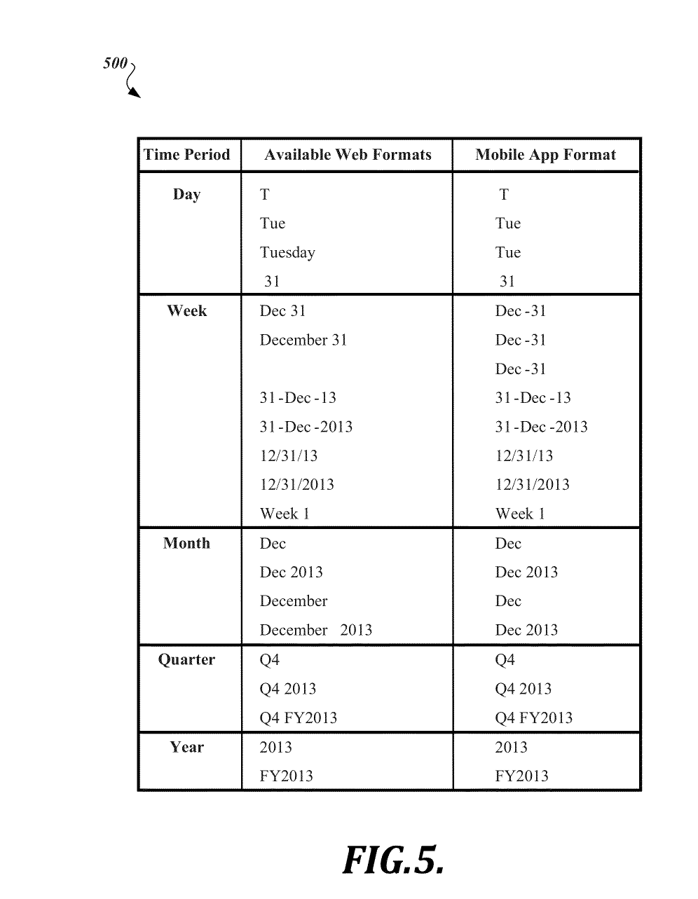

Many different date formats may be used for time markers. FIG. 5 is a table 500 depicting illustrative date formats for time markers that may be used in a Web format and in a mobile application format, respectively. Settings such as names or abbreviations for days and months, ordering of days, months, and years, and other date format settings may vary, e.g., on a per-user basis depending on location settings, language settings, or the like. Described embodiments may include default date format settings, and may provide ways to override default date format settings (e.g., on a per-sheet or per-project basis). Depending on device capabilities, device settings, operating system, or other factors, it may be necessary or desirable to set the date format based on an inspection of the user's locale (e.g., using CFLocale for Apple iOS) and reformat the date provided by the application into the correct format by using a date formatter (e.g., NSDateFormatter for Apple iOS).

An interactive chart view application running on a local device can provide all of the time markers used for a chart. Alternatively, sufficient information to calculate time markers can be stored on the local device. If time markers are calculated locally, a remote service may still provide some date information directly (e.g., the month that begins a fiscal year, such as January, April, July, or October). Fiscal year information may be important for providing the right year for fiscal-year-formatted dates and for displaying the right index for quarter and week numbers if they are associated with the fiscal year.

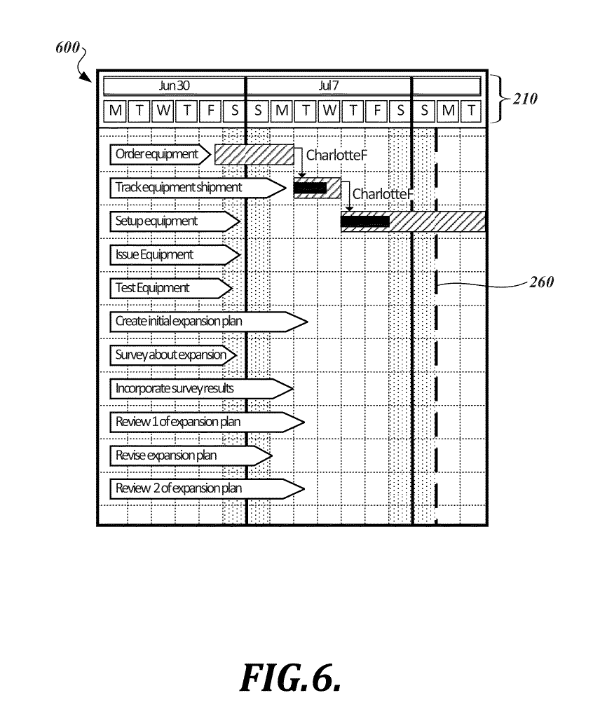

FIG. 6 is a screen shot of another illustrative chart view 600 comprising column dividers corresponding to different levels of hierarchy in a time scale. In the example shown in FIG. 6, the chart view 600 includes a background with grid lines that divide task rows into boxes for each time unit. The task rows and columns can be scrolled (e.g., vertically and horizontally, respectively) to view other tasks or time units that may not be visible on the display.

In at least some embodiments, there are two types of column dividers—a secondary column divider (representing smaller time units in the time scale) and a primary column divider (representing larger time units in the time scale). In the example shown in FIG. 6, the secondary column dividers divide the task rows into days, and the primary column dividers divide the task rows into weeks, with each primary column divider overlaying or replacing a secondary column divider between Saturday and Sunday. The primary column divider can be represented in a way that distinguishes it from the secondary column divider, e.g., with a darker and/or thicker line, as shown in FIG. 6. Additionally, as shown in FIG. 6, the primary column divider may be longer than the secondary divider.

At the level of zoom shown in FIG. 6, the boxes created by the grid lines represent days of the week in the respective task rows. This level of zoom may be a default zoom level that is adjustable to other zoom levels as desired. The shading below time markers labeled “S” indicates that these days (Saturday and Sunday, respectively) are not generally considered to be working days for the purposes of the project schedule. Other non-working days (such as holidays) also can be shaded or otherwise distinguished visually from working days. In at least some embodiments, the visual distinction (e.g., shading) for non-working days can be removed at zoom levels representing larger time scales (e.g., weeks/months, etc.).

In some cases, a primary column divider may not line up with a corresponding secondary column divider. For example, in a week/month time scale, the primary column divider may appear between two secondary column dividers if, as is often the case, the end of a month does not coincide with the end of a week. The primary column divider can be positioned behind the time markers in the header row, if necessary, in order to avoid obscuring the time markers.

Referring again to FIG. 6, the current day can be represented in a visually distinctive way (e.g., as a dashed line 260 that extends from the top task row to the bottom of the chart, in between the current day and the following day). The current day may also be represented at other zoom levels (e.g., weeks/months, etc.).

### Illustrative User Interface Operations for Interactive Chart Views

In described embodiments, user interface operations (e.g., scrolling operations, zoom operations, panning operations, activation of user interface elements such as buttons or menu options, etc.) can be initiated and/or controlled in response to user input events (e.g., a touch of a button, a gesture or tap on a touchscreen, or the like). User interface operations permit user interaction with charts and views. The available user interface operations, as well as the particular input that is used to initiate or control the available user interface options, can vary depending on factors such as the capabilities of the device (e.g., whether the device has a touchscreen), the underlying operating system, user interface design, user preferences, or other factors.

Scrolling operations (e.g., horizontal scrolling or vertical scrolling) can be initiated and/or controlled by user input such as a button press or touch, a gesture on a touchscreen (e.g., a horizontal flick gesture), or the like. Horizontal scrolling allows a user to view content that is outside the display area in the horizontal direction, and vertical scrolling allows a user to view content that is outside the display area in the vertical direction. Some elements may be altered (e.g., in terms of size, shape, or content) in response to scrolling. For example, the shape, size, or content of task name labels can be altered in response to horizontal scrolling in a Gantt view, as described in detail above. In at least one embodiment, vertical scrolling allows headers (such as time scale headers) to continue to be displayed as the user scrolls vertically (e.g., to view additional task rows in a Gantt view), thereby providing the user with consistent visual cues as to the information that is being displayed.

Zoom operations (e.g., zoom-in operations, zoom-out operations) can be initiated and/or controlled by user input such as a button press or touch, a gesture on a touchscreen (e.g., a tap or pinch gesture), or the like. Zoom operations in a chart view (e.g. a Gantt view) can be useful for viewing or interacting with a chart at different levels of detail. The effect of a zoom operation may vary depending on the current zoom level, the direction and/or magnitude of the zoom, the nature of the user input, or other factors.

In described embodiments, zoom operations can be initiated and/or controlled by gestures in a touch-enabled interface. For example, a zoom-in operation can be initiated by a pinch gesture, in which two points of contact (e.g., by a user's fingers) are brought closer together during the gesture, and a zoom-out operation can be initiated by an “un-pinch” gesture, in which two points of contact are moved further apart during the gesture. The effect of a zoom operation can depend on the magnitude of the gesture (e.g., the change in distance between the contact points), the direction of the gesture (e.g., whether the gesture is a pinch or un-pinch gesture), the angle of the gesture (e.g., the angle relative to a horizontal or vertical axis), the current zoom level, and/or other factors. A single gesture can lead to any of several possible zoom effects depending on the characteristics of the gesture, as described in further detail below.

In some embodiments, zoom operations can be used to adjust time scales in a chart view (e.g., a Gantt view). A time scale may have an upper zoom limit and a lower zoom limit. If a zoom operation extends beyond a limit of a current time scale and another time scale is available beyond the respective limit, the zoom operation can cause the view to transition from the current time scale to another time scale (e.g., from day/week to week/month, or vice versa).

Transitions between time scales can be implemented in many different ways. For example, to provide a smooth transition between time scales, a dissolve effect or other visual effect can be used to animate transitions between day/week, week/month, month/quarter, quarter/year, or other time scales. As another example, column lines can appear or disappear or change appearance in response to zoom operations.

Views also can be adjusted in response to changes in zoom level within the same time scale. For example, an intermediate level of zoom that does not exceed a limit of a current time scale may be accompanied by a change in font size in headers and/or labels, a change in column size and/or row size, or the like. As an example, a Gantt view can respond to zoom-out and zoom-in operations by moving column lines (e.g., day lines) closer and further apart, respectively, within the same time scale.

In at least one embodiment, a Gantt view supports zoom operations along the time axis and the task axis, which can be carried out either individually or together, responsive to pinch and un-pinch gestures. A zoom operation directed to only the time axis (e.g., a horizontal axis) can be used to grow or shrink the columns representing time units and/or change time scales, allowing the user to view the same number of tasks over a longer or shorter time period.

Time scale adjustments may be constrained by time scale adjustment constraints. Such constraints may be based on task visibility. For example, time scale adjustments may be constrained to keep all tasks visible (e.g., if a project includes a number of tasks below a threshold number). This may be useful, for example, where a project contains a small number of tasks (e.g., 3, 4, or 5 tasks). As another example, time scale adjustments may be constrained to keep a minimum number of tasks visible (e.g., 2 tasks). As another example, time scale adjustments may be constrained by requiring at least one entire task (including beginning and end points) to be visible at an adjusted time scale. This may be useful, for example, to avoid zooming in so far on the time axis that the beginning point and/or end point of a task (or set of tasks) is not visible. Other task visibility constraints are also possible. Time scale adjustment constraints also can be based on user preferences and/or other factors, including factors unrelated to task visibility.

Referring again to FIGS. 4A-D, zoom operations along the time axis 204 can cause the corresponding chart view 400 to transition between time scales. FIG. 4A shows a day/week time scale, FIG. 4B shows a week/month time scale, FIG. 4C shows a month/quarter time scale, and FIG. 4D shows a quarter/year time scale. As shown, task bars and group bars vary in length within the view depending on the current zoom level. In response to a zoom-out operation that causes the chart view 400 to transition from a day/week time scale to a week/month time scale, day lines can fade out (e.g., when a pre-defined zoom-level limit is reached), week lines can be modified (e.g., by changing color), and month lines may come in from the sides of the display area.

In described embodiments, a zoom operation can be directed to the task axis (e.g., a vertical axis) to view more or fewer tasks over the same time period. The zoom level along the task axis may also affect legibility of the task labels. For example, font sizes and/or label sizes may be configured to grow (and perhaps become more legible) as fewer tasks are displayed, or shrink (and perhaps become less legible) as more tasks are displayed. In order to limit any adverse effects on legibility, a limit on the number of tasks to be viewed can be set, e.g., to prevent font size and/or label size from getting too small. Such a limit may vary depending on the size of the display, user preferences, or other factors.

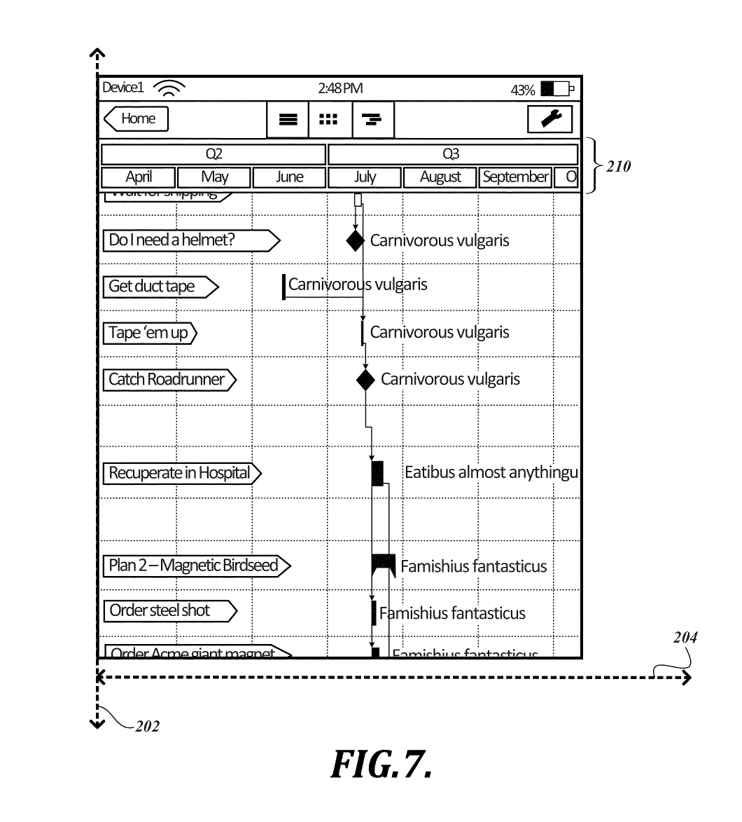

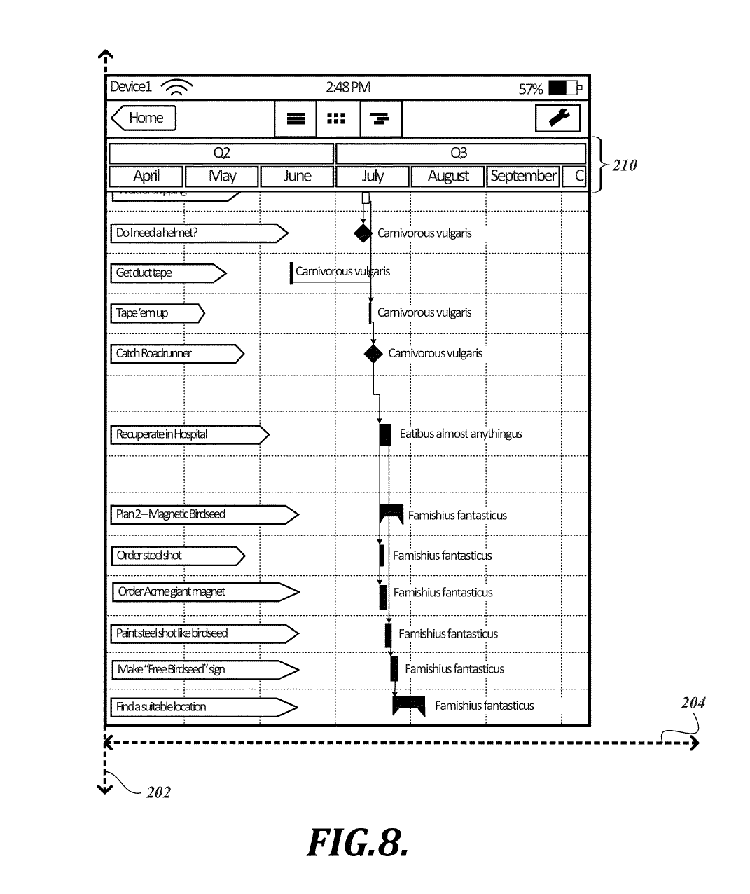

FIG. 7 is a screen shot of an illustrative chart view at an initial zoom level, and FIG. 8 is a screen shot of the illustrative chart view of FIG. 7 in a view state that is zoomed out along the task axis 202. In FIG. 7, several tasks are shown in a month/quarter time scale, and in FIG. 8, a greater number of tasks (with correspondingly smaller font and label sizes relative to FIG. 7) are shown in the same month/quarter time scale. While the length of the task bars remains constant, the length of the task name labels may grow to fit the newly increased font size allowed by their greater height. In at least one embodiment, the task name labels can grow to a maximum length, which may be expressed as a fraction of the screen width (e.g., 50% of the screen width but not more).

A zoom operation directed to both the time axis and the task axis can be used to adjust both the time period to be viewed and the number of tasks to be viewed (e.g., in response to a single pinch or un-pinch gesture). In at least one embodiment, a diagonal pinch gesture is used to zoom on both the time axis and the task axis. The system can determine whether a pinch gesture is diagonal or not by comparing the angle of the pinch gesture with the horizontal or vertical axis.

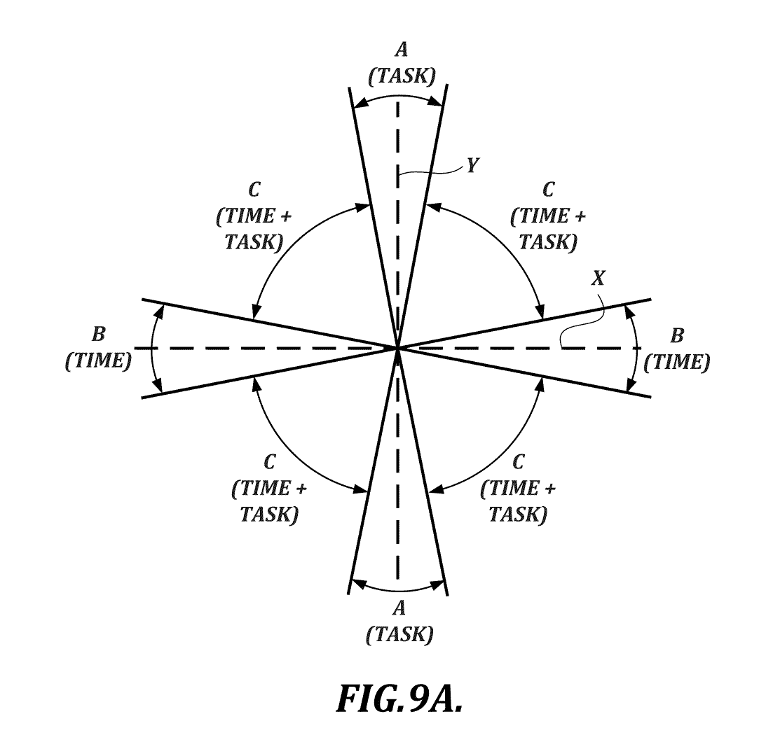

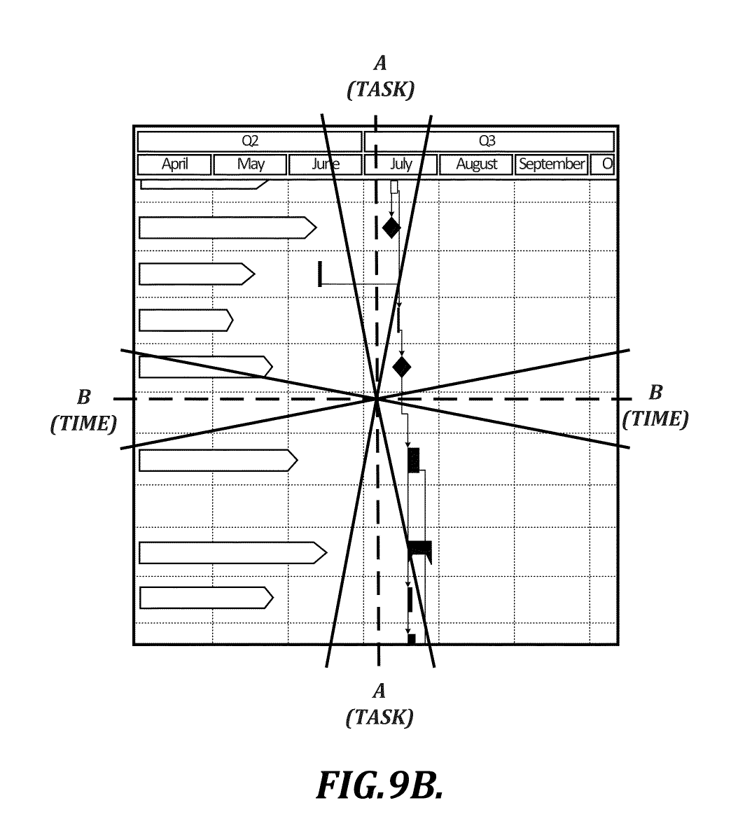

In at least one embodiment, the system determines whether a pinch gesture is vertical, horizontal, or diagonal as follows: if the line between the two contact points of the pinch is within 15° of horizontal, the pinch gesture is horizontal; if the line between the two contact points of the pinch is within 15° of vertical, the pinch gesture is vertical; otherwise, the pinch gesture is diagonal. These ranges are represented in FIG. 9A as angles A, B, and C, respectively, where A represents angles for zooming on the task axis, B represents angles for zooming on the time axis, and C represents angles for zooming on the time axis and the task axis. As shown, a horizontal pinch gesture can be used to zoom on the horizontal axis X (e.g., the time axis), a vertical pinch gesture can be used to zoom on the vertical axis Y (e.g., the task axis), and a diagonal pinch gesture can be used to zoom on both the horizontal axis and the vertical axis. FIG. 9B shows angles A and B superimposed on a screen shot of an illustrative chart view at an initial zoom level similar to the chart view shown in FIG. 7. (The C angles are not shown in FIG. 9B for ease of illustration.) A pinch gesture along the task axis (angle B) can be used to perform a zoom action that results in an updated chart view similar to the chart view shown in FIG. 8, or other pinch gestures can be used to perform other zoom actions, as described herein.

In at least one embodiment, a diagonal pinch gesture in a chart view causes the same degree of zoom on both the time axis and the task axis, regardless of the specific angle. However, the application of the same degree of zoom along each axis may differ in the respective effects presented in the view, as described above. Alternatively, the degree of zoom caused by a diagonal pinch gesture can vary depending on the specific angle (e.g., with a greater degree of zoom on the time axis if the angle is closer to horizontal, or with a greater degree of zoom on the task axis if the angle is closer to vertical).

In addition to scrolling operations and zoom operations, other user interface operations can permit other types of user interaction with charts and views. For example, a user can interact with user interface elements by performing a tap gesture or a press-and-hold gesture on a designated hit area in a row, if the hit area is within the display area. A tap or press-and-hold gesture can be recognized if the gesture occurs in a designated area of the display corresponding to a portion of the user interface. Such a designated area is referred to herein as a “hit area.”

In at least one embodiment, the following user interface operations can be initiated by a tap gesture on a designated hit area in a row, if the hit area is within the display area.

Tap expand/collapse element: If an expand/collapse element (e.g., a box) is present (e.g., if a row has children) tapping in an area on or near the element (e.g., a row-height square area) can toggle the expanded/collapsed state. In at least one embodiment, the hit or tap area extends beyond the visible element and potentially even covers a small part of other content outside the expand/collapse element (e.g., text to its right) to ensure that the hit area is big enough for easy interaction.

Tap label to show and/or center task on display: If the user taps the label of a task (or a milestone or group) the view can horizontally scroll (e.g., so the left-hand side of the task bar is in the middle of the screen). This scrolling operation can be animated, but quick (e.g., 300 ms). This scrolling operation also can include shifting other content (e.g., a table or grid) to the side, if needed.

Tap bar/marker to open a row view: Tapping on the bar or marker (e.g., a task bar, a group bar, a milestone marker, etc.) in a row can open a row view. In at least one embodiment, the row to be viewed is opened in a “view row” form, and the user can move to the next or previous row or invoke an editing operation from that view. If the row is edited, the chart view can be refreshed to show any corresponding changes.

The above effects may be presented temporally, for a period of time after invocation by the user, or for so long as the user holds a given button or item on the page, for a “show me” effect on the data element selected. In this way, a temporary view of the information may be viewed by the user, without changing the display permanently.

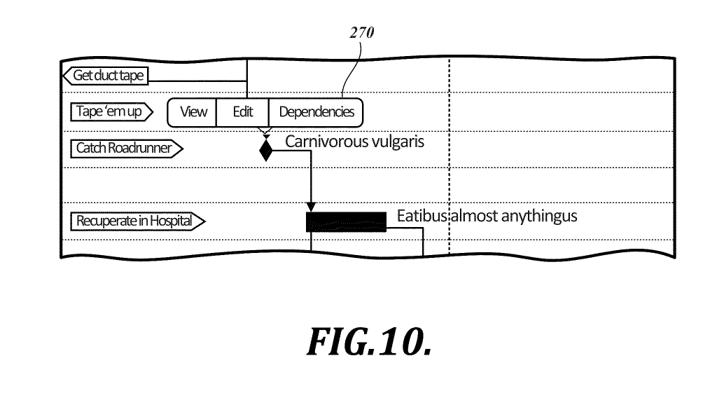

In at least one embodiment, a row menu can be activated by a press-and-hold gesture on a designated hit area in a row, if the hit area is within the display area. FIG. 10 is a screen shot of a portion of an illustrative chart view comprising a row menu. As shown in FIG. 10, the row menu 270 can include, for example, a View button, an Edit button, and a Dependencies button. In the example shown in FIG. 10, the View button opens a “view row” form for the row (similar to the effect of a tap on the corresponding bar or marker, as described above), the Edit button opens an “edit row” form for the row (similar to the effect of tapping the “Edit” option from a “view row” dialog, as described above), and the Dependencies button highlights the dependencies for the selected task.

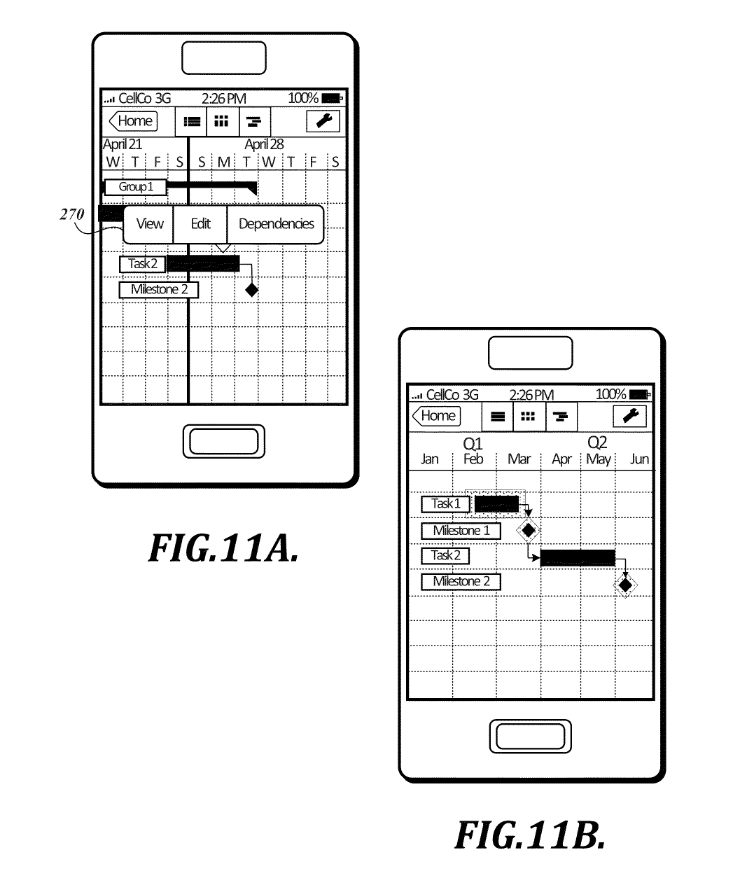

Dependencies can be highlighted in different ways. For example, using the illustrative row menu 270 shown in FIG. 11A, connection line precedents and/or antecedents can be highlighted with an effect such as a shadow or “glow” effect, as shown in FIG. 11B. Connection lines also can be highlighted, e.g., with a change in line thickness, a color change, and/or other effects. Different colors and/or effects can be applied to distinguish precedents and antecedents. For example, precedents can be marked with a blue shadow and a blue arrow, and antecedents can be marked with a green shadow and a green arrow. Connection lines can merge or overlap. If any merged lines have dependencies, the color of the merged line can be adjusted to reflect the dependency. If a merged connection line has both a precedent and an antecedent, it can be colored like a precedent or distinguished in some other way.

The extent of dependency highlighting may be limited to one task before and/or after the selected task, or more dependencies may be highlighted. Related milestones may be highlighted or ignored for highlighting purposes.

Optionally, the user may invoke a scroll-to operation by tapping on an arrow associated with a dependency, such as an antecedent. This scroll-to operation may be, e.g., a temporary zoom-to or snap-back scroll in which, after showing the antecedent or precedent (e.g., by centering the view on the antecedent or precedent), viewing of the antecedent returns to the original view position, or a move-to scroll that repositions the view (e.g., by centering the view on the antecedent or precedent) and comes to rest at the antecedent or precedent's location on the chart.

Highlighting can be temporary, or it can be displayed until dismissed. Some gestures may cause highlighting to be dismissed, while other gestures may allow highlighting to continue to be displayed. In at least one embodiment, a tap gesture is effective to dismiss the highlighting while pinch and flick gestures do not dismiss the highlighting. As shown in FIG. 11B, it is possible to perform operations such as a zoom operation that changes the time scale of a chart view without dismissing the highlighting.

Highlighting also can be preserved in a persistent state. Persistent highlighting can be used for generating a tracing of dependencies between tasks, milestones, and the like. Such tracings can be preserved in a snapshot format (e.g., as an image or as a saved state of an interactive chart view) for later reference. In one illustrative scenario, tracings can be saved and shared with other users, e.g., by sending a tracing (e.g., in an image file) to other users or by allowing other users to access a saved state of an interactive chart view.

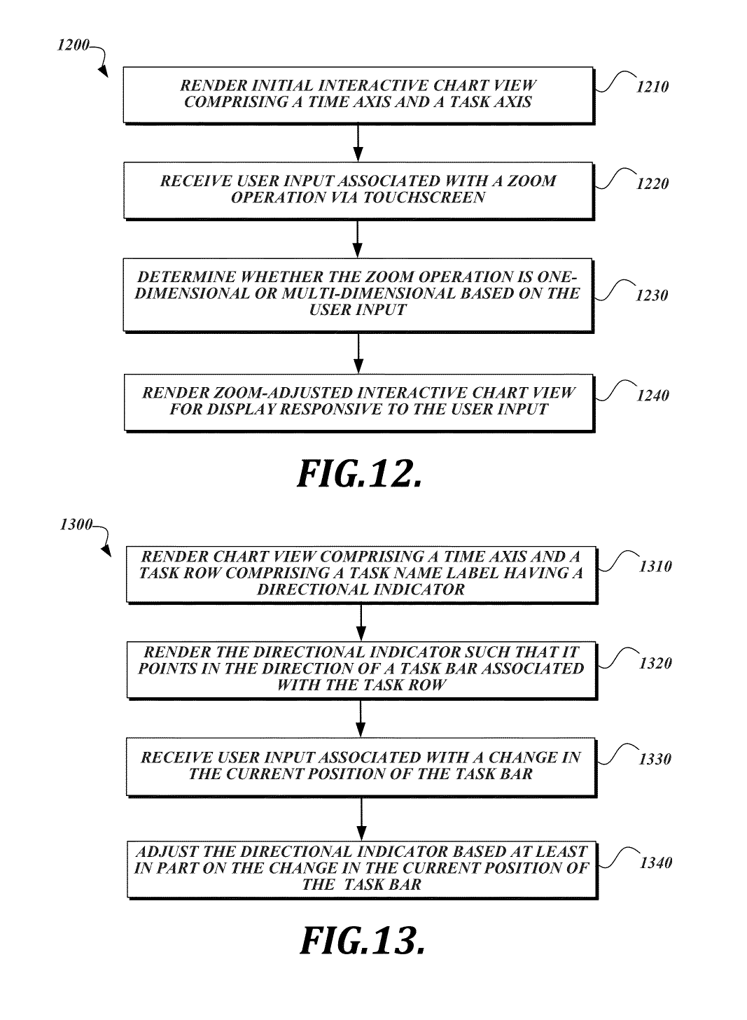

FIGS. 12 and 13 are flow charts illustrating computer-implemented methods according to one or more embodiments of the present disclosure. In the illustrative method 1200 shown in FIG. 12, at step 1210, a computing device comprising a touchscreen renders an initial interactive chart view comprising a time axis and a task axis. At step 1220, the computing device receives user input associated with a zoom operation via the touchscreen. At step 1230, the computing device determines whether the zoom operation is one-dimensional or multi-dimensional based on the user input. At step 1240, the computing device renders a zoom-adjusted interactive chart view for display responsive to the user input. The zoom-adjusted interactive chart view includes at least one aspect that has been adjusted in view of the zoom operation. For example, the zoom-adjusted interactive chart view may be zoomed in or out on the time axis or the task axis, or both, relative to the initial interactive chart view. Other user input can be used to modify the interactive chart view in other ways. For example, additional user input such as tap gestures, press-and-hold gestures, and the like can be used to manipulate task labels or task rows, highlight dependencies, render row views or menus, or otherwise provide modified views of task information response to the additional user input.

In the illustrative method 1300 shown in FIG. 13, at step 1310, a computing device renders a chart view comprising a time axis and a task row comprising a task name label having a directional indicator. At step 1320, the computing device renders the directional indicator such that it points in the direction of a task bar associated with the task row. At step 1330, the computing device receives user input associated with a change in the current position of the task bar. At step 1340, the computing device adjusts the directional indicator based at least in part on the change in the current position of the task bar.

### Operating Environment

Unless otherwise specified in the context of specific examples, described techniques and tools may be implemented by any suitable computing devices, including, but not limited to, laptop computers, desktop computers, smart phones, tablet computers, and/or the like.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location.

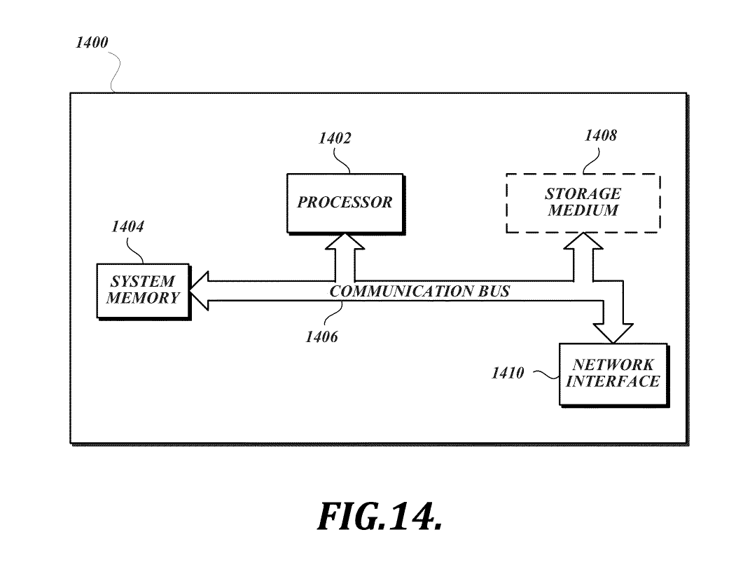

FIG. 14 is a block diagram that illustrates aspects of an exemplary computing device 1400 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 1400 includes at least one processor 1402 and a system memory 1404 connected by a communication bus 1406. Depending on the exact configuration and type of device, the system memory 1404 may be volatile or nonvolatile memory, such as read only memory (“ROM”), random access memory (“RAM”), EEPROM, flash memory, or other memory technology. Those of ordinary skill in the art and others will recognize that system memory 1404 typically stores data and/or program modules that are immediately accessible to and/or currently being operated on by the processor 1402. In this regard, the processor 1402 may serve as a computational center of the computing device 1400 by supporting the execution of instructions.

As further illustrated in FIG. 14, the computing device 1400 may include a network interface 1410 comprising one or more components for communicating with other devices over a network. Embodiments of the present disclosure may access basic services that utilize the network interface 1410 to perform communications using common network protocols. The network interface 1410 may be used to access services such as a distributed file system, a search service, a database service (e.g., a SQL database service), or other services. The network interface 1410 may also include a wireless network interface configured to communicate via one or more wireless communication protocols, such as WiFi, 2G, 3G, 4G, LTE, WiMAX, Bluetooth, and/or the like, with locally networked or remotely networked systems and devices.

In the exemplary embodiment depicted in FIG. 14, the computing device 1400 also includes a storage medium 1408. However, services may be accessed using a computing device that does not include means for persisting data to a local storage medium. Therefore, the storage medium 1408 depicted in FIG. 14 is optional. In any event, the storage medium 1408 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and non-removable media implemented in any method or technology capable of storing information, such as computer-readable instructions, data structures, program modules, in-memory databases, or other data. In this regard, the system memory 1404 and storage medium 1408 depicted in FIG. 14 are examples of computer-readable media.

For ease of illustration and because it is not important for an understanding of the claimed subject matter, FIG. 14 does not show some of the typical components of many computing devices. In this regard, the computing device 1400 may include input devices, such as a keyboard, keypad, mouse, trackball, microphone, video camera, touchpad, touchscreen, electronic pen, stylus, and/or the like. Such input devices may be coupled to the computing device 1400 by wired or wireless connections including RF, infrared, serial, parallel, Bluetooth, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 1400 (e.g., a client device), or can be integral components of the computing device 1400. In some embodiments, multiple input devices may be combined into a single, multifunction input device (e.g., a video camera with an integrated microphone). Any suitable input device either currently known or developed in the future may be used with systems described herein.

The computing device 1400 may also include output devices such as a display, speakers, printer, etc. The output devices may include video output devices such as a display or touchscreen. The output devices also may include audio output devices such as external speakers or earphones. The output devices can be separate from and communicatively coupled to the computing device 1400, or can be integral components of the computing device 1400. In some embodiments, multiple output devices may be combined into a single device (e.g., a display with built-in speakers). Further, some devices (e.g., touchscreens) may include both input and output functionality integrated into the same input/output device. Any suitable output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### Extensions and Alternatives

Although some examples are described herein with regard to illustrative touch-enabled mobile computing devices and a corresponding interactive chart view application that can be executed on the illustrative devices, the principles described herein also can be applied to any other computing devices having limited display areas, whether such computing devices employ touchscreen input or other input modes. Described embodiments can be applied to any size display to provide powerful and flexible capabilities, even though the need may be more acute for smaller displays.

For touch-enabled devices, many different types of touch input can be used, and touch input can be interpreted in different ways. Inertia effects, friction effects, and the like can be used to provide a more realistic feel for touch input. For example, in a touch-enabled interface, a flick gesture can be used to initiate a scrolling motion at an initial velocity that gradually decreases (e.g., based on a friction coefficient) before coming to rest.

A “tools” menu can be provided to enhance the functionality of an interactive chart view application. For example, functions such as share (e.g., to share a link to a chart), send (e.g., to send a copy of a chart or a related file), refresh (e.g., to update a chart view after editing), help (e.g., to access a web-based or application-based help library), and cancel (e.g., to discard edits), can be provided by a tools menu.

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

Many alternatives to the user interfaces described herein are possible. In practice, the user interfaces described herein may be implemented as separate user interfaces or as different states of the same user interface, and the different states can be presented in response to different events, e.g., user input events. The elements shown in the user interfaces can be modified, supplemented, or replaced with other elements in various possible implementations.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

The embodiments of the invention in which an exclusive property or privilege is claimed are defined as follows:

1. A computer-implemented method comprising:
by a computing device comprising a touchscreen, rendering an initial interactive chart view comprising a time axis and a task axis;
by the computing device, receiving first user input associated with a zoom operation via the touchscreen;
by the computing device, based at least in part on the first user input, determining whether the zoom operation is a one-dimensional zoom operation or a multi-dimensional zoom operation; and
by the computing device, rendering a zoom-adjusted interactive chart view for display responsive to the first user input.

2. The computer-implemented method of claim 1, wherein the zoom operation is a one-dimensional zoom operation.

3. The computer-implemented method of claim 2, wherein the one-dimensional zoom operation comprises a time-axis zoom operation, and wherein the zoom-adjusted interactive chart view is zoomed in or out on the time axis relative to the initial interactive chart view.

4. The computer-implemented method of claim 2, wherein the one-dimensional zoom operation comprises a task-axis zoom operation, and wherein the zoom-adjusted interactive chart view is zoomed in or out on the task axis relative to the initial interactive chart view.

5. The computer-implemented method of claim 1, wherein the zoom operation is a multi-dimensional zoom operation.

6. The computer-implemented method of claim 5, wherein the multi-dimensional zoom operation comprises a zoom along the time axis and a zoom along the task axis, and wherein the zoom-adjusted interactive chart view is zoomed in or out on the time axis and the task axis relative to the initial interactive chart view.

7. The computer-implemented method of claim 1, wherein the initial interactive chart view comprises an initial number of task rows to be displayed, and wherein the zoom-adjusted interactive chart view comprises an adjusted number of task rows to be displayed.

8. The computer-implemented method of claim 1, wherein the initial interactive chart view comprises an initial time scale and an initial number of task rows to be displayed, and wherein the zoom-adjusted interactive chart view comprises an adjusted number of task rows to be displayed at the initial time scale.

9. The computer-implemented method of claim 1, wherein the initial interactive chart view comprises an initial time scale, and wherein the zoom-adjusted interactive chart view comprises an adjusted time scale.

10. The computer-implemented method of claim 1, wherein the initial interactive chart view comprises an initial time scale and an initial number of task rows to be displayed, and wherein the zoom-adjusted interactive chart view comprises an adjusted time scale with the initial number of task rows to be displayed.

11. The computer-implemented method of claim 1, wherein the interactive chart views comprise Gantt charts.

12. The computer-implemented method of claim 1, wherein the first user input comprises a pinch gesture.

13. The computer-implemented method of claim 1, wherein the computing device is in communication with a server computer, and wherein the interactive chart views are generated using project schedule information received from the server computer.

14. The computer-implemented method of claim 13, wherein one or more changes to the project schedule information are synchronized back to the server.

15. The computer-implemented method of claim 1, wherein the initial interactive chart view comprises a number of connection lines representing dependencies to be displayed, and wherein the zoom-adjusted interactive chart view comprises an adjustment of the number, positioning, or orientation of the connection lines.

16. The computer-implemented method of claim 1, wherein the initial interactive chart view comprises task rows to be displayed, and wherein the zoom-adjusted interactive chart view comprises height-adjusted task rows.

17. The computer-implemented method of claim 1 further comprising:
by the computing device, receiving second user input associated with an operation in a task row via the touchscreen; and
by the computing device, rendering a modified view of task information responsive to the second user input.

18. The computer-implemented method of claim 17, wherein the second user input comprises a tap gesture on an expand/collapse element in a row having children.

19. The computer-implemented method of claim 17, wherein the second user input comprises a tap gesture on a task label, and wherein rendering the modified view of task information comprises repositioning the task label on the display.

20. The computer-implemented method of claim 19, wherein repositioning the task label on the display comprises centering the task label on the display.

21. The computer-implemented method of claim 17, wherein the second user input comprises a tap gesture on an element of a task row, and wherein rendering the modified view of task information comprises rendering a row view.

22. The computer-implemented method of claim 17, wherein the second user input comprises a press-and-hold gesture on a task row, and wherein rendering the modified view of task information comprises rendering a row menu.

23. The computer-implemented method of claim 22, wherein the row menu comprises a dependencies button configured to, when activated, highlight dependences for a task.

24. A computer-implemented method comprising:
by a computing device, rendering a chart view comprising a time axis and a task row, wherein the task row comprises a task name label having a directional indicator;
by the computing device, rendering the directional indicator such that the directional indicator points in the direction of a task bar at a current position, wherein the task bar is associated with the task row;
by the computing device, receiving user input associated with a change in the current position of the task bar; and
by the computing device, adjusting the directional indicator based at least in part on the change in the current position of the task bar.

25. The computer-implemented method of claim 24, wherein the directional indicator is initially positioned at a first end of the task name label, and wherein adjusting the directional indicator comprises positioning the directional indicator at a second end of the task name label.

26. The computer-implemented method of claim 24, wherein adjusting the directional indicator comprises adjusting the size or orientation of the directional indicator.

27. The computer-implemented method of claim 24, wherein adjusting the directional indicator comprises adjusting the size of the directional indicator in proportion to a distance between the task name label and the task bar.

28. The computer-implemented method of claim 24, wherein the chart view comprises a Gantt chart view.

29. The computer-implemented method of claim 24, wherein the computing device is in communication with a server computer, and wherein the chart view comprises project schedule information received from the server computer.

30. A computer-implemented method comprising:
by a computing device comprising a touchscreen, rendering a chart view for a project comprising tasks, the chart view comprising a time axis and a task axis;
by the computing device, detecting a pinch gesture via the touchscreen, the pinch gesture corresponding to a zoom operation; and
by the computing device, automatically adjusting a time scale of the time axis responsive to the pinch gesture subject to a time scale adjustment constraint that is based at least in part on the tasks.

31. The computer-implemented method of claim 30, wherein the time scale adjustment constraint comprises a minimum number of tasks to be visible at the adjusted time scale.

32. The computer-implemented method of claim 30, wherein the time scale adjustment constraint requires an entire task to be visible at the adjusted time scale.
